(19) United States
(12) Patent Application Publication
(10) Pub. No.: US 2022/0325652 A1
(43) Pub. Date: Oct. 13, 2022

(54) AUTOMOTIVE ENGINE EXHAUST SYSTEM

(71) Applicant: ZZ Performance, LLC, Wyoming, MI (US)

(72) Inventor: Alexander R. Timothy Soden, Grand Rapids, MI (US)

(21) Appl. No.: 17/716,145

(22) Filed: Apr. 8, 2022

Related U.S. Application Data
(60) Provisional application No. 63/173,349, filed on Apr. 9, 2021.

(51) Int. Cl. F01N 13/08; F01N 13/16; F01N 13/18; F16L 41/02

(52) U.S. Cl. CPC F01N 13/08; F01N 13/16; F01N 13/1805; F01N 13/1844; F16L 41/02

(57) ABSTRACT

An X-pipe for an automotive engine exhaust system is made from a pair of 3-inch diameter metal pipes, each formed with a central bend and a pair of outboard bends. Each pipe is formed to have an oval-shaped central opening, and the two pipes are welded together along a central plane at the oval-shaped central openings. The resulting X-pipe may then be welded into an exhaust system and then installed on a vehicle with an internal combustion engine, and reduces rasp on startup, harmonizes exhaust flow between the cylinder banks on the engine, and improves tonal pleasantness of the exhaust note.

### CROSS REFERENCE TO RELATED APPLICATION

The present application claims the benefit of U.S. provisional application Ser. No. 63/173,349, filed Apr. 9, 2021, which is hereby incorporated herein by reference in its entirety.

### FIELD OF THE INVENTION

This invention relates in general to exhaust piping systems for internal combustion engines, in particular for automotive engines.

### BACKGROUND OF THE INVENTION

For automobiles with internal combustion engines, metal piping is used to direct hot exhaust gases away from the engine, typically through a catalytic converter, to a muffler, and then out into the atmosphere through a tail pipe located at a rear or side of the automobile. In the case of high performance vehicles, the design of an exhaust system affects not only the power output of the engine, but also the sound of the engine through the exhaust system, which can be an important quality for some vehicle owners and drivers.

### SUMMARY OF THE INVENTION

The present invention provides a generally X-shaped pipe that is particularly well-suited for installation in a “cat-back” exhaust system (i.e., that portion of the exhaust system located downstream of the catalytic converter) for a Cadillac ATS-V with turbocharged V6 engine, and for similar vehicular applications. As compared to the stock (unmodified) exhaust system installed by the vehicle manufacturer, installation of the X-shaped pipe (“X-pipe”) of the present invention reduces “raspy” sound on startup, harmonizes exhaust flow between the cylinder banks (three cylinders feed into each pipe of the X-pipe), and improves tonal pleasantness of the exhaust note.

In one form of the present invention, an X-pipe for an automotive engine exhaust system is made from a pair of 3-inch diameter metal pipes, such as constructed from grade 304 stainless steel. Each pipe is formed to have an oval-shaped central opening with an outer length of about 7.5 inches and an inner length of about 7.15 inches. The two pipes are welded together along a central plane at the oval-shaped central openings. Each pipe has a central bend of about 48 degrees bent along a 5-inch radius and away from the oval-shaped central openings, and also a pair of opposite bends extending away from the central bends. The opposite bends extend along about 24 degrees of curvature along a 5-inch radius, opposite to the bend direction of the respective central bends, so that gas flowing through opposing ends of the pipes will flow approximately parallel to the central plane where the oval-shaped central openings meet.

According to another form of the present invention, a method is provided for forming and installing an X-pipe into an automotive engine exhaust system. The method includes forming two metal pipes with three bends in each, cutting an oval-shaped opening in a midsection of each pipe, and mating the pipes together at their openings. A central bend of about 48 degrees is formed in each pipe by bending the pipes along a 5-inch radius. At each opposite end of each of the metal pipes, and outboard of the central bends, a pair of opposite bends of about 24 degrees are formed along 5-inch radii. As a result, the opposite ends of each of the metal pipes are approximately parallel to one another. The oval-shaped central openings are formed along an outer radius of the central bend in each of the metal pipes such that respective opposite end portions of the metal pipes curve away from the central openings. Preferably, the central openings each having an outer length of about 7.5 inches and an inner length of about 7.15 inches. The metal pipes are aligned with their respective oval-shaped central openings placed together along a central plane, where they are welded together to form the X-pipe. The opposite ends of the metal pipes of the X-pipe are then welded to respective ones of two upstream pipe ends and the two downstream pipe ends of a cat-back exhaust system for a vehicle.

These and other objects, advantages, purposes and features of the present invention will become apparent upon review of the following specification in conjunction with the drawings.

### BRIEF DESCRIPTION OF THE DRAWINGS

FIG. 1 is a top perspective view of an X-pipe automotive engine exhaust system of the present invention;

FIG. 2 is a side perspective view of one half of the X-pipe of FIG. 1, shown partially formed;

FIG. 3 is a top plan view of the X-pipe of FIG. 1;

FIG. 4 is a side elevation view of the half of the X-pipe of FIG. 2; and

FIG. 5 if a top plan view of the half of the X-pipe of FIG. 4.

### DETAILED DESCRIPTION OF PREFERRED EMBODIMENTS

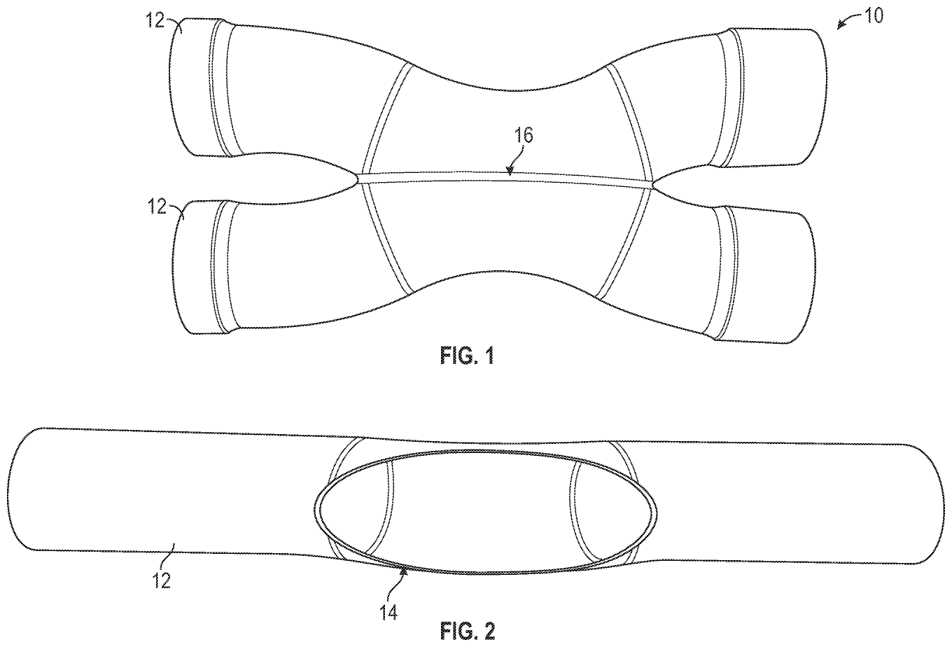

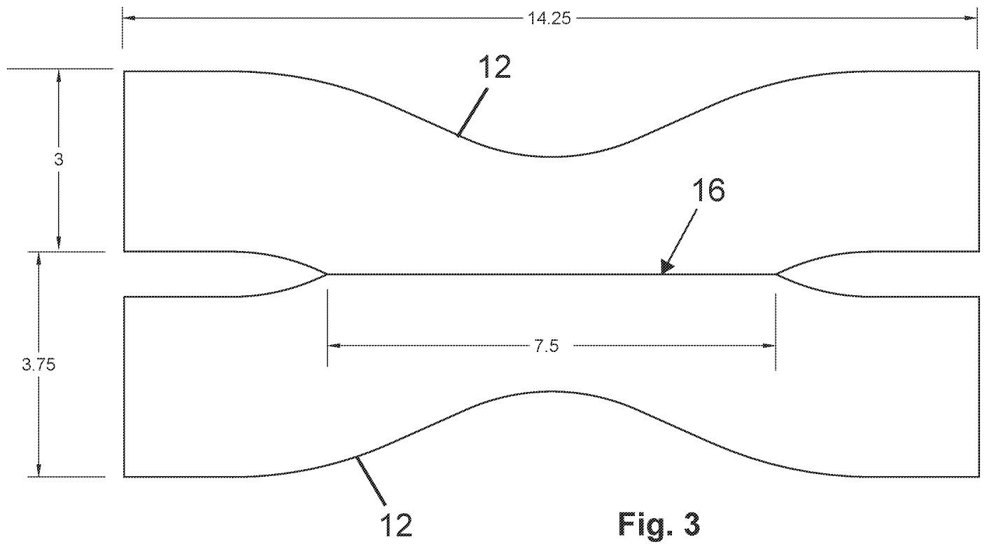

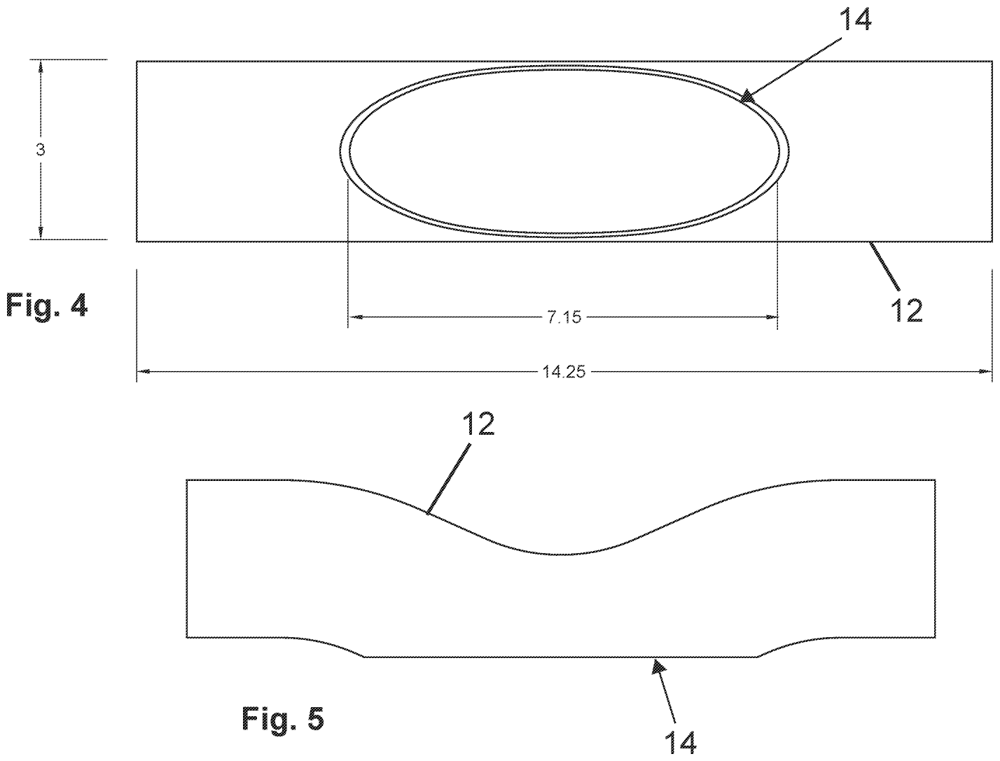

Referring now to the drawings and the illustrative embodiments depicted therein, an X-shaped exhaust pipe section or “X-pipe” 10 (FIGS. 1-5) is provided for installation or use within a full cat-back exhaust system, which is that portion of an internal combustion engine's exhaust system that is located downstream of a catalytic converter. In particular, the dimensions shown in FIGS. 3 and 4, which are marked in inches, depict such a system optimized for use in a cat-back exhaust system for a twin-turbocharged 3.6 L V6 LF4 engine fitted to a Cadillac ATS-V. The X-pipe 10, which includes a crossover or mixing region as describe below, reduces rasp on startup, harmonizes exhaust flow between the cylinder banks on the V6 turbo charged engine and to improve tonal pleasantness of the exhaust note. The various angles, curvatures, and marked dimensions are optimized for being fitted to a Cadillac ATS-V cat-back system in the rear of the exhaust tunnel, near the rear differential. Suitable cat-back exhaust systems are available, for example, from ZZ Performance, LLC, of Wyoming, Mich. In one advantageous arrangement the vehicle's stock exhaust is removed and a suitable cat-back exhaust system including the X-pipe 10 is installed in its place. In the Cadillac ATS-V application the X-pipe 10 may be located approximately 68 inches straight-line distance and approximately 81 inches of pipe length from the OEM catalytic converters. It has been found that placing the X-pipe 10 further upstream (closer to the catalytic converters) or further back (closer to the tail pipes) in the ATS-V cat-back system may lead to less desirable tonal qualities.

The X-pipe 10 is made from two bent tubes 12 of 304 stainless steel, which are bent on a 5.0 inch center line radius (“CLR”), and which are each cut to have an oval-shaped open region 14 along a central portion thereof. As best shown in FIGS. 1 and 3, the two bent tubes 12 each have three (3) bends for a total of six (6) bends in the tubes of the finished X-pipe 10. Four (4) of the bends (at the opposite inlet and outlet ends) are at 24 degrees and two (2) of the bends (at the center) are at 48 degrees. The overall length of the X-pipe 10, optimized for the application noted above, is 14.25″. As shown in only FIG. 1, the finished X-pipe 10 may be formed with outwardly-flared tube ends to facilitate insertion of exhaust pipe portions of the vehicle's stock exhaust, prior to welding. Once installed into the cat-back system, the X-pipe 10 has five (5) TIG-welded joints including an oval-shaped weld 16 where the two oval-shaped open regions 14 of the two bent tubes 12 meet, and one weld at each of the open flared tube ends that receive respective exhaust pipe portions of the vehicle's cat-back exhaust system.

X-pipe 10 may be manufactured by bending the 3-inch diameter metal pipes 12 to create a central bend of about 48 degrees along a 5-inch radius. A pair of end bends are then formed in the opposite direction of the central bend. The end bends are each about 24 degrees of curvature bent along another 5-inch radius, so that the opposite ends of each metal pipe are approximately parallel to one another. The oval-shaped central openings 14 are then formed along the outer radius of the central bend in each of the metal pipes such that respective opposite end portions of the metal pipes curve away from the central openings. In a preferred embodiment, the central openings each have an outer length of about 7.5 inches and an inner length of about 7.15 inches. The metal pipes 12 are then aligned with their respective oval-shaped central openings 14 placed together along a central plane. The metal pipes 12 are then welded together where they meet at the oval-shaped central openings 14 along the central plane, thus forming X-pipe 10.

Optionally, the pipe ends are flared outwardly to receive 3-inch pipe ends of an automotive exhaust system. X-pipe 10 may be installed into the automotive engine exhaust system by cutting adjacent sections of two exhaust pipes out of the cat-back portion of the engine exhaust system. These cuts leave two upstream pipe ends and two downstream pipe ends. The opposite ends of the metal pipes 12 of the X-pipe 10 receive respective ones of the upstream pipe ends and the downstream pipe ends of the cat-back system.

Dimensions for the formed X-pipe 10 are shown in inches in FIG. 3, and dimensions for one of the bent tubes 12, including the oval-shaped open region 14, are shown in inches in FIG. 4. In addition to the desirable installation location of the X-pipe 10 in the cat-back system described above, the combinations of tube diameter, overall length, and the dimensions of the oval-shaped open region 14, where exhaust gases from respective banks of engine cylinders meet and mix, eliminates stock exhaust “rasp” (a harsh metallic sound) on startup and improves sound tone under driving load.

Changes and modifications in the specifically described embodiments may be carried out without departing from the principles of the present invention, which is intended to be limited only by the scope of the appended claims, as interpreted according to the principles of patent law including the doctrine of equivalents.

1. An X-pipe for an automotive engine exhaust system, said X-pipe comprising:
a pair of 3-inch diameter pipes each having an oval-shaped central opening having an outer length of about 7.5 inches and an inner length of about 7.15 inches, wherein said pipes are welded together along a central plane at said oval-shaped central openings;
each of said pipes having a central bend of about 48 degrees bent along a 5-inch radius and away from said oval-shaped central openings;
each of said pipes each having a pair of opposite bends extending away from said central bends so that gas flowing through opposing ends of said pipes flows approximately parallel to said central plane where said oval-shaped central openings meet, where each of said opposite bends is about 24 degrees bent along a 5-inch radius.

2. The X-pipe of claim 1, wherein said pipes comprise 304 stainless steel.

3. The X-pipe of claim 1, wherein said pipes are spaced apart by about 0.75 inch at respective ones of said opposing ends.

4. The X-pipe of claim 1, wherein said pipes have an overall pre-installed length of about 14.25 inches.

5. The X-pipe of claim 1, wherein said opposing ends of said pipes are welded into a cat-back exhaust system at a rear end portion of an exhaust tunnel, proximate to a rear differential of a vehicle comprising a Cadillac ATS-V equipped with twin-turbocharged 3.6 L LF4 V6 engine.

6. The X-pipe of claim 5, wherein said opposing ends of said pipes are positioned about 81 inches of pipe length downstream from a catalytic converter of said vehicle.

7. A method of forming and installing an X-pipe into an automotive engine exhaust system, said method comprising:
forming, in each of two 3-inch diameter metal pipes, a central bend of about 48 degrees bent along a 5-inch radius;
forming, at each opposite end of each of the metal pipes and outboard of the central bends, a pair of opposite bends of about 24 degrees bent along a 5-inch radius, wherein the opposite ends of each of the metal pipes are approximately parallel to one another.
forming an oval-shaped central opening along an outer radius of the central bend in each of the metal pipes such that respective opposite end portions of the metal pipes curve away from the central openings, the central openings each having an outer length of about 7.5 inches and an inner length of about 7.15 inches;
aligning the metal pipes with their respective oval-shaped central openings placed together along a central plane;
welding the metal pipes together where they meet at the oval-shaped central openings along the central plane to form the X-pipe; and
welding the opposite ends of the metal pipes of the X-pipe to respective ones of two upstream pipe ends and the two downstream pipe ends of a cat-back exhaust system for a vehicle.

8. The method of claim 7, further comprising flaring the opposite ends of the metal pipes of the X-pipe to a larger diameter, and inserting the two upstream pipe ends and the two downstream pipe ends of the cat-back system into the opposite ends of the metal pipes of the X-pipe, prior to said welding the opposite ends of the metal pipes of the X-pipe.

9. The method of claim 7, wherein the metal pipes comprise 304 stainless steel.

10. The method of claim 7, wherein the pipes are spaced apart by about 0.75 inch at respective ones of the opposing ends.

11. The method of claim 7, wherein the X-pipe has an overall length of about 14.25 inches.

12. The method of claim 7, further comprising installing the cat-back exhaust system onto the vehicle with the X-pipe located about 81 inches of pipe length downstream from a catalytic converter of the vehicle.
